(19) United States
(12) Patent Application Publication
(10) Pub. No.: US 2019/0160877 A1
(43) Pub. Date: May 30, 2019

(54) PNEUMATIC TIRE

(71) Applicant: Toyo Tire & Rubber Co., Ltd., Itami-shi (JP)

(72) Inventor: Kazuki Ohta, Itami-shi (JP)

(73) Assignee: Toyo Tire & Rubber Co., Ltd., Itami-shi (JP)

(21) Appl. No.: 16/189,514

(22) Filed: Nov. 13, 2018

(30) Foreign Application Priority Data
Nov. 27, 2017 (JP) 2017-227116

(51) Int. Cl. B60C 11/01

(52) U.S. Cl. CPC B60C 11/01; B60C 2011/013

(57) ABSTRACT

A pneumatic tire includes a buttress portion provided between a tread portion and a side wall portion and an uneven portion provided in the buttress portion, in which the uneven portion includes three or more recessed grooves provided along a tire circumferential direction and two or more ridges provided between the recessed grooves, the recessed grooves and the ridges are continuously formed alternately in a tire radial direction to make a corrugated shape on a meridian section, and apexes of the ridges are positioned on a visible outline of the buttress portion.

### BACKGROUND OF THE INVENTION

### 1. Field of the Invention

The present invention relates to a pneumatic tire.

### 2. Description of Related Art

In a pneumatic tire, a ground contact pressure is normally increased in the vicinity of a ground contact end in a tread portion during travelling, therefore, uneven wear in which a wear amount in the vicinity of the ground contact end in the tread portion is larger than other portions may occur.

As a method of suppressing such uneven wear, there are disclosed a tire in which a recessed groove extending along a tire circumferential direction is provided in a buttress portion provided between a tread portion and a side wall portion to thereby reduce the ground contact pressure in the vicinity of the ground contact end in the tread portion and to suppress occurrence of uneven wear in JP-A-2010-285032, JP-A-2000-6615 and JP-H5-48202.

However, the effect of reducing the ground contact pressure is not sufficiently obtained by the recessed groove disclosed in the Patent Literatures, and it is necessary to increase a depth or a groove width of the recessed groove for obtaining sufficient effect. When the depth or the groove width of the recessed groove is increased, there is a problem that cracks are easily generated from the recessed groove as a starting point.

### SUMMARY OF THE INVENTION

In view of the above, an object of the present invention is to provide a pneumatic tire capable of suppressing uneven wear occurring in the vicinity of the ground contact end in the tread portion while suppressing generation of cracks in the pneumatic tire including the recessed groove in the buttress portion.

A pneumatic tire according to the present invention includes a buttress portion provided between a tread portion and a side wall portion and an uneven portion provided in the buttress portion, in which the uneven portion includes three or more recessed grooves provided along a tire circumferential direction and two or more ridges provided between the recessed grooves, the recessed grooves and the ridges are continuously formed alternately in a tire radial direction to make a corrugated shape on a meridian section of the uneven portion, and apexes of the ridges are positioned on a visible outline of the buttress portion.

### BRIEF DESCRIPTION OF THE DRAWINGS

FIG. 1 is a half sectional view of a pneumatic tire according to a first embodiment of the present invention;

FIG. 2 is a side view showing a relevant part of the pneumatic tire of FIG. 1;

FIG. 3 is an enlarged view of a relevant part of FIG. 1;

FIG. 4 is a cross-sectional view shown by partially enlarging a relevant part of a pneumatic tire according to Comparative Example 1; and

FIG. 5 is a cross-sectional view shown by partially enlarging a relevant part of a pneumatic tire according to Comparative Example 2.

### DESCRIPTION CF EMBODIMENTS

Hereinafter, an embodiment of the present invention will be explained with reference to the drawings.

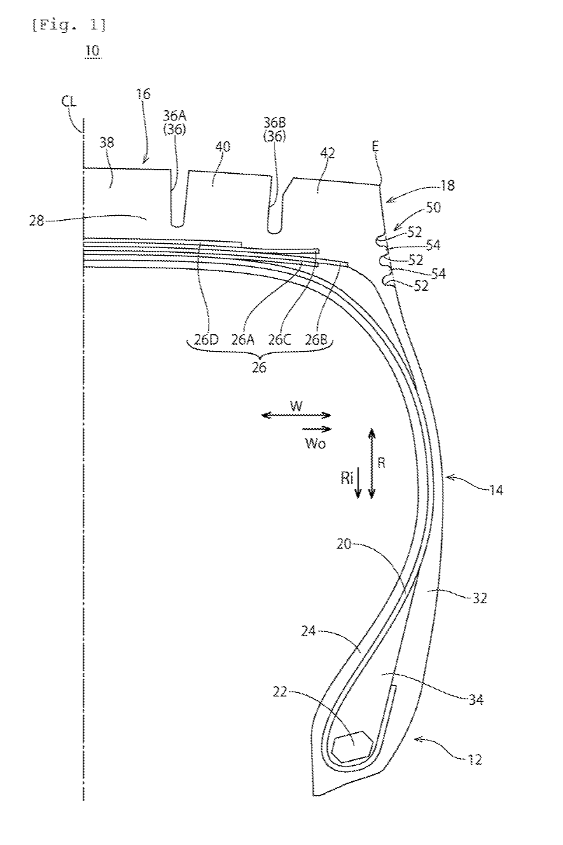

FIG. 1 is a right-side half sectional view of a pneumatic tire 10 according to the embodiment taken along a meridian section including a tire axis. As the pneumatic tire 10 is a symmetrical tire, a left side half is not shown.

The pneumatic tire 10 shown in FIG. 1 includes a right and left pair of bead portions 12, a right and left pair of side wall portions 14 extending from the bead portions 12 outwardly in a radial direction, a tread portion 16 forming a tread surface and a right and left pair of buttress portions 18 arranged on a tire radial direction inner side of the tread portion 16. Here, the buttress portion 19 is a boundary region between the tread portion 16 and the side wall portion 14, which is provided so as to connect the tread portion 16 to the side wall portion 14.

The pneumatic tire 10 includes a carcass ply 20 provided to be stretched between the pair of bead portions 12 in a toroidal shape. In the pair of bead portions 12, ring-shaped bead cores 22 are respectively embedded.

The carcass ply 20 extends from the tread portion 16 to the bead portion 12 through the buttress portion 18 and the side wall portion 14 and locked by the bead core 22 at the bead portion 12, which reinforces the respective portions 12, 14, 16 and 18. The carcass ply 20 is locked by folding peripheral portions of the bead cores 22 from the inner side to the outer side in a tire width direction at both end portions. An inner liner 24 for holding air pressure is arranged on an inner side of the carcass ply 20.

The carcass ply 20 is formed of at least one ply formed by arranging an organic fiber cord at a given angle (for example, 70° to 90°) with respect to a tire circumferential direction and coated with topping rubber, and is formed by one ply in this example. As the cord for forming the carcass ply 20, for example, organic fiber cords made of polyester fiber, rayon fiber, aramid fiber, nylon fiber and the like are preferably used.

In the side wall portion 14, a side wall rubber 32 is provided on an outer side (namely, a tire outer surface side) of the carcass ply 20. In the bead portion 12, a bead filler 34 made of a hard rubber material extending toward a tire radial direction outer side in a tapered manner is arranged on an outer peripheral side of the bead core 22.

A belt 26 is arranged on the outer peripheral side of the carcass ply 20 in the tread portion 16. That is, the belt 26 is provided between the carcass ply 20 and a tread rubber 28 in the tread portion 16. The belt 26 is formed of plural pieces of cross belt plies arranged so that belt cords are inclined at a given angle (for example, 10° to 35°) with respect to the tire circumferential direction. As the belt cord, a steel cord or an organic fiber cord having a high tensile force may be used.

The belt 26 has a four-layer structure containing a first belt 26A positioned on the innermost side in a tire radial direction inner side Ri, and second belt 26B, a third belt 26C and a fourth belt 26D laminated in order on the outer peripheral side thereof, in which the second belt 26B is the maximum width belt having the widest width.

On the surface of the tread portion 16, four main grooves 36 extending along the tire circumferential direction are provided. Specifically, the main grooves 36 include a pair of center main grooves 36A arranged on both sides with a tire equatorial plane CL interposed therebetween, and a pair of shoulder main groove 36B provided on a tire width direction outer side Wo of the pair of center main grooves 36A. The tire width direction outer side Wo indicates a side away from the tire equatorial plane CL in a tire width direction W.

According to the above four main grooves 36, a central land portion 38 is formed between the two center main grooves 36A, intermediate land portions 40 are formed between the center main grooves 36A and the shoulder main grooves 36B and shoulder land portions 42 are formed on the tire width direction outer side Wo of the two shoulder main grooves 36B in the tread portion 16. The central land portions 38 and the intermediate land portions 40 are block lines separated in the tire circumferential direction by lateral grooves. The shoulder land portions 42 are formed by ribs continued in the tire circumferential direction.

An outer end in the tire width direction of a tread surface 42a in the shoulder land portion 42 forms a tread ground contact end E, to which the buttress portion 13 extending inwardly in a tire radial direction and forming an upper part of a tire side surface is connected.

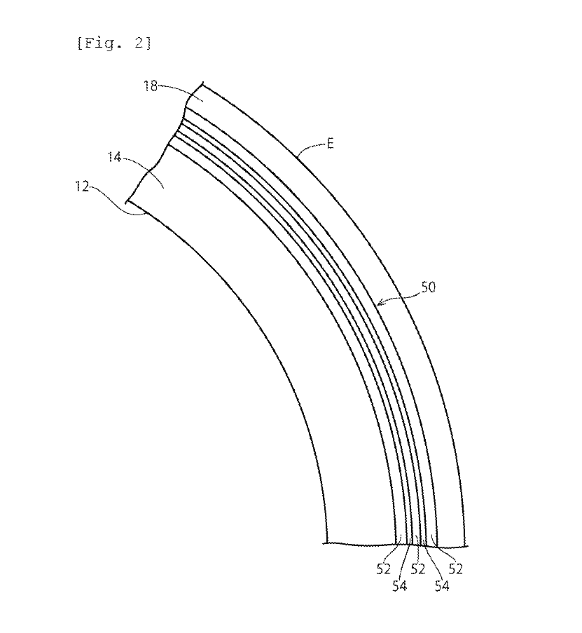

Then, an uneven portion 50 including recessed grooves 52 and ridges 54 is provided on an outer surface of the buttress portion 18 along the tire circumferential direction as shown in FIG. 1 to FIG. 3.

The recessed grooves 52 are annular recessed portions continuously provided over the entire circumference in the tire circumferential direction, and three or more grooves (three in the embodiment) are provided at intervals in a tire radial direction R.

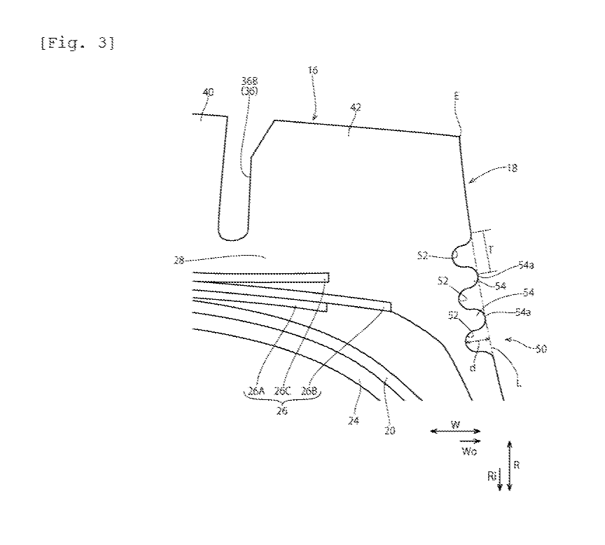

The ridges 54 are annular ridges continuously provided over the entire circumference in the tire circumferential direction sectioned between respective recessed grooves 52, and two or more ridges (two in the embodiment) are provided in the tire radial direction R. Apexes 54a of the ridges 54 are positioned on a visible outline L of the buttress portion 18. Here, the visible outline L of the buttress portion 18 is a curved line smoothly connecting contour lines of the buttress portion 13 not including the uneven portion 50 on the meridian section of the tire 10 shown in FIG. 3, which corresponds to a contour line of the buttress portion in a case where the uneven portion 50 is not provided.

The uneven portion 50 has a corrugated shape in which the recessed grooves 52 and the ridges 54 are continuously formed alternately in the tire radial direction R on the meridian section shown in FIG. 1 and FIG. 3. That is, in the uneven portion 50, wall surfaces forming the recessed grooves 52 and wall surfaces forming ridges 54 are smoothly connected in shape of the meridian section. The uneven portion 50 may have, for example, a sine wave shape, a sawtooth wave shape, a rectangular wave shape, a triangular wave shape or a trapezoidal wave shape.

In the uneven portion 50, shapes of the recessed grooves 52 and the ridges 54 in the meridian section may be approximately the same as each other. The uneven portion 50 may have a corrugated shape in which the recessed grooves 52 and the ridges 54 are connected with smooth curved surfaces in the tire radial direction.

The uneven portion 50 may be formed at a position overlapping with the second belt 26B as the maximum width belt in the tire radial direction R.

Here, examples of dimensions of the uneven portion 50 formed in the buttress portion 18 are cited with reference to FIG. 3. A depth of the recessed groove 52 (a distance from the visible outline L of the buttress portion 18 to a bottom of the recessed groove 52) “d” may be set to 1.5 mm or more to 3.5 mm or less, an opening width T of the recessed groove 52 may be set to 1.5 mm or more to 5.5 mm or less. When the depth “d” of the recessed groove 52 is set to 1.5 mm or more, the good effect of reducing the ground contact pressure can be obtained, and when the depth “d” of the recessed groove 52 is set to 3.5 mm or less, generation of cracks in the buttress portion 18 can be suppressed. When the opening width T of the recessed groove 52 is set to 1.5 mm or more, the good effect of reducing the ground contact pressure can be obtained, and when the opening width T of the recessed groove 52 is set to 5.5 mm or less, generation of cracks in the buttress portion 18 can be suppressed.

The respective dimensions in the specification are in a normal state with no load in which a pneumatic tire is fitted to a normal rim and is filled with a normal internal pressure except for a case particularly mentioned. In the specification, the tread ground contact end indicates an end portion of the tread surface in the tire width direction contacting the road surface in the normal load state where the pneumatic tire assembled to the normal rim and filled with the normal internal pressure is placed vertically on a flat road surface and a normal load is added.

The normal rim is a rim defined by respective standards for each tire in a standard system including standards to which the tire is conformed. For example, the normal rim will be a standard rim in JATMA, “Design Rim” in TRA and “Measuring Rim” in ETRTO. The normal internal pressure is an air pressure defined by respective standards for each tire in the standard system including standards to which the tire is conformed. For example, the normal internal pressure will be the maximum air pressure in JATMA, the maximum value written in a table “TIRE LOAD LIMITS AT VARIOUS COLD INFLATION PRESSURES” in TRA, and “INFLATION PRESSURE” in ETRTO, however, 180 kPA when the tire is for a passenger car. The normal load is a load defined by respective standards for each tire in a standard system including standards to which the tire is conformed. For example, the normal load will be the maximum load ability in JTAMA, the maximum value written in the above table in TRA, and “LOAD CAPACITY” in ETRTO, however, a load corresponding to 88% of the above load when the tire is for the passenger car.

In the pneumatic tire 10 according to the present embodiment, the uneven portion 50 including three or more recessed grooves 52 provided along the tire circumferential direction is provided in the buttress portion 18, which reduces rigidity in the vicinity of the tread ground contact end E. Therefore, it is possible to suppress increase of the ground contact pressure in the vicinity of the tread ground contact end E and suppress uneven wear occurring in the vicinity of the tread ground contact end E in the pneumatic tire 10.

Additionally, the uneven portion 50 provided in the buttress portion IS includes three recessed grooves 52 and two ridges 54 provided between respective recessed grooves 52, forming the corrugated shape in which the recessed grooves 52 and the ridges 54 are continuously formed in the tire radial direction R on the meridian section. Accordingly, the uneven portion 50 is flexibly deformed easily in the tire radial direction R considering a volume of the recessed groove 52 (a recessed amount from the visible outline L) provided in the buttress portion 18. Accordingly, the increase in ground contact pressure in the vicinity of the tread ground contact end E can be sufficiently suppressed without providing the large recessed groove 52, and uneven wear occurring in the vicinity of the tread ground contact end E can be suppressed while suppressing generation of cracks.

Furthermore, the apexes 54a of the ridges 54 are positioned on the visible outline L of the buttress portion 18, therefore, generation of cracks in the uneven portion 50 can be suppressed without making the buttress portion IS excessively recessed.

When the shapes of the recessed grooves 52 and the ridges 54 in the meridian section forming the uneven portion 50 are approximately the same as each other, deformation stress acting on the uneven portion 50 is not locally concentrated and easily distributed to the entire uneven portion 50. As a result, the uneven portion 50 is flexibly deformed easily in the tire radial direction R while suppressing generation of cracks, and uneven wear occurring in the vicinity of the tread ground contact end E can be suppressed.

Moreover, the meridian section of the recessed grooves 52 and the ridges 54 forming the uneven portion 50 makes the corrugated shape in which the recessed groove 52 and the ridge 54 are connected in the tire radial direction R with smooth curved surfaces, therefore, deformation stress acting on the uneven portion 50 is not locally concentrated and easily distributed to the entire uneven portion 50. Accordingly, the uneven portion 50 is flexibly deformed easily in the tire radial direction R while suppressing generation of cracks, and uneven wear occurring in the vicinity of the tread ground contact end E can be suppressed.

Though the case where the three recessed grooves 52 and the two ridges 54 are provided in the uneven portion 50 has been explained in the embodiment, the present invention is not limited to this, and four or more recessed grooves 52 and three or more ridges 54 may be provided in the uneven portion 50.

The above embodiment is cited as an example and does not intend to limit the scope of the invention. The novel embodiment may be achieved in other various manners, and various kinds of omission, replacement and alterations may occur within a scope not departing from the gist of the invention.

### EXAMPLES

Hereinafter, the present invention will be explained further specifically by examples, and the present invention is not limited by these examples.

Pneumatic tires of Example 1, Comparative Examples 1 and 2 (tire size: 295/75R22.5) were experimentally produced. These prototype tires were fabricated by setting the tire internal structure and the basic tread pattern to the same and by changing the shape of the uneven portion provided in the buttress portion 18.

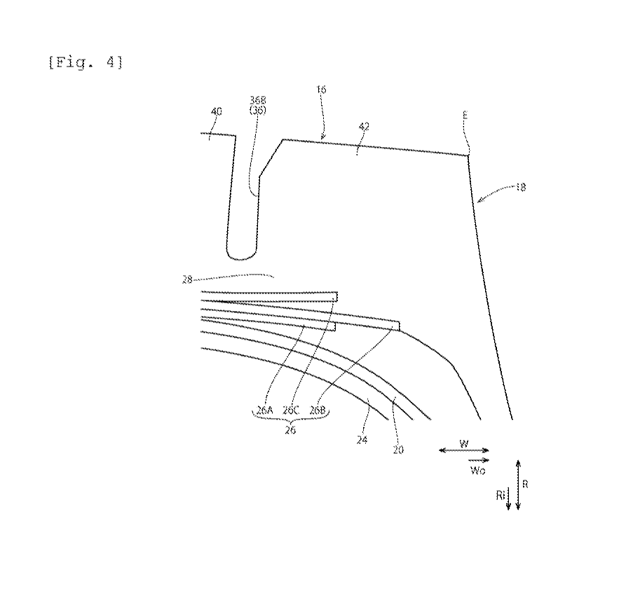

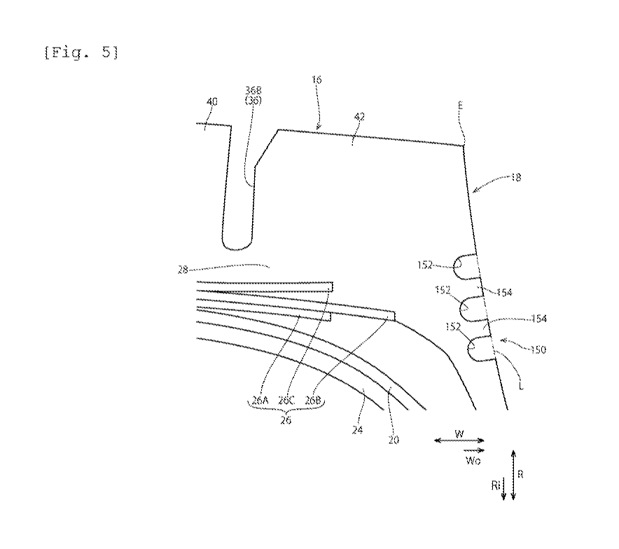

Specifically, the pneumatic tire in Example 1 is the pneumatic tire shown in FIG. 1 to FIG. 3. The pneumatic tire in Comparative Example 1 is a pneumatic tire shown in FIG. 4, which is an example in which the uneven portion 50 is not provided in the buttress portion 18. The pneumatic tire in Comparative Example 2 is a pneumatic tire shown in FIG. 5, which is an example in which an uneven portion 150 having three recessed grooves 152 and two ridges 154 is provided in the buttress portion 18 but the recessed grooves 152 and the ridges 154 do not form the corrugated shape connected in the tire radial direction R on the meridian section.

The depth “d” of the recessed grooves 52 and 152 provided in the pneumatic tires of Example 1 and Comparative Example 2 was set to 5.5 mm and the opening width T was set to 8.5 mm.

Evaluations were conducted for respective pneumatic tires of Example 1, comparative Example 1 and 2.

### Uneven Wear Resistance

Test tires were attached to front wheels of a tractor head of a long-distance transport truck and widths of stepped wear were measured in the tire width direction after traveling on a dry road surface for 80000 km, then, reciprocals thereof were evaluated by indexes. Evaluations are shown by index evaluation when a value of Comparative Example 1 is set as 100. The larger the numeral is, the better uneven wear resistance is.

TABLE 1

| | | Comparative | Comparative |
|---|---|---|---|
| | Example 1 | Example 1 | Example 2 |
| Depth of recessed | 5.5 | — | 5.5 |
| groove d (mm) | | | |
| Opening width of | 8.5 | — | 8.5 |
| recessed groove T (mm) | | | |
| Uneven wear | 110 | 100 | 103 |
| resistance | | | |

Results are as shown in Table 1. In Example 1, the uneven wear resistance was largely improved as compared with Comparative Example 2 in which the same number of recessed grooves with the same depth “d” and the opening width T were provided.

What is claimed is:

1. A pneumatic tire comprising:
a buttress portion provided between a tread portion and a side wall portion; and
an uneven portion provided in the buttress portion,
wherein the uneven portion includes three or more recessed grooves provided along a tire circumferential direction and two or more ridges provided between the recessed grooves,
the recessed grooves and the ridges are continuously formed alternately in a tire radial direction to make a corrugated shape on a meridian section, and
apexes of the ridges are positioned on a visible outline of the buttress portion.

2. The pneumatic tire according to claim 1,
wherein shapes of the recessed grooves and the ridges in the meridian section are the same.

3. The pneumatic tire according to claim 1,
wherein the meridian section of the uneven portion makes a corrugated shape in which the recessed grooves and the ridges are continuously formed with curved surfaces.

4. The pneumatic tire according to claim 1,
wherein the tread portion includes a plurality of belts, and
the uneven portion is provided at a position overlapping with the widest belt in a tire width direction in the plurality of belt in the tire radial direction.

5. The pneumatic tire according to claim 1,
wherein a depth of the recessed groove is 1.5 mm or more to 3.5 mm or less.

6. The pneumatic tire according to claim 1,
wherein an opening width of the recessed groove is 1.5 mm or more to 5.5 mm or less.

7. The pneumatic tire according to claim 1,
wherein the uneven portion is formed by the three recessed groove and the two ridges.
